(19) United States
(12) Patent Application Publication
(10) Pub. No.: US 2013/0158145 A1
(43) Pub. Date: Jun. 20, 2013

(54) POLYURETHANE HAVING HIGH LIGHT REFRACTION

(71) Applicants: Hans-Josef Laas, Odenthal (DE); Dorota Greszta-Franz, Solingen (DE); Reinhard Halpaap, Odenthal (DE); Dieter Mager, Leverkusen (DE); Hans-Ulrich Meier-Westhues, Leverkusen (DE)

(72) Inventors: Hans-Josef Laas, Odenthal (DE); Dorota Greszta-Franz, Solingen (DE); Reinhard Halpaap, Odenthal (DE); Dieter Mager, Leverkusen (DE); Hans-Ulrich Meier-Westhues, Leverkusen (DE)

(73) Assignee: BAYER INTELLECTUAL PROPERTY GMBH, Monheim (DE)

(21) Appl. No.: 13/811,162

(22) PCT Filed: Jul. 15, 2011
(86) PCT No.: PCT/EP2011/062181

§ 371 Date: Feb. 22, 2013

(30) Foreign Application Priority Data
Jul. 20, 2010 (DE) 10 2010 031 684.9

(51) Int. Cl. C08G 18/76

(52) U.S. Cl. CPC C08G 18/76
USPC 521/159; 528/59; 524/871

(57) ABSTRACT

The present invention relates to the use of solvent-free low-monomer polyisocyanates based on araliphatic diisocyanates for the production of light- and weather-resistant polyurethane bodies having a high light refraction and low dispersion.

The preparation of light-fast and weather-resistant plastics by reaction of aliphatic or cycloaliphatic polyisocyanates with compounds which contain acid hydrogen atoms is known. Depending on the nature of the H-acid reaction partners, such as e.g. polyols, polyamines and/or polythiols, polyaddition products having, for example, urethane, urea and/or thiourethane structures are formed here.

The general term “polyurethanes” is also used in the following as a synonym for the large number of different polymers which can be prepared from polyisocyanates and H-acid compounds.

For various uses, for example as a lightweight substitute for mineral glass for the production of panes for automobile and aircraft construction or as embedding compositions for optical, electronic or optoelectronic components, an increasing interest in transparent, light-fast polyurethane compositions is currently to be recorded in the market.

For high performance optical uses in particular, such as e.g. for lenses or spectacle lenses, there is generally the desire for plastics materials which have a high light refraction and at the same time a low dispersion (high Abbe number).

The preparation of transparent polyurethane compositions having a high refractive index has already been frequently described. As a rule, so-called araliphatic diisocyanates, i.e. those diisocyanates in which the isocyanate groups are present bonded to an aromatic system via aliphatic radicals, are employed as the polyisocyanate component in this context. Due to their aromatic structures, araliphatic diisocyanates give polyurethanes which have an increased refractive index, and at the same time the aliphatically bonded isocyanate groups guarantee the light fastness and low tendency towards yellowing which are required for high performance uses.

U.S. Pat. No. 4,680,369 and U.S. Pat. No. 4,689,387 describe, for example, polyurethanes and polythiourethanes which are suitable as lens materials, and in the preparation of which specific sulfur-comprising polyols or mercapto-functional aliphatic compounds are combined with araliphatic diisocyanates, such as e.g. 1,3-bis(isocyanatomethyl)benzene (m-xylylene-diisocyanate, m-XDI), 1,4-bis(isocyanatomethyl)benzene (p-xylylene-diisocyanate, p-XDI), 1,3-bis(2-isocyanatopropan-2-yl)benzene (m-tetramethylxylylene-diisocyanate, m-TMXDI) or 1,3-bis(isocyanatomethyl)-2,4,5,6-tetrachlorobenzene, to achieve particularly high refractive indices.

Araliphatic diisocyanates, such as m- and p-XDI or m-TMXDI, are also mentioned as the preferred polyisocyanate component for the preparation of high-refraction lens materials in a large number of further publications, such as e.g. EP-A 0 235 743, EP-A 0 268 896, EP-A 0 271 839, EP-A 0 408 459, EP-A 0 506 315, EP-A 0 586 091 and EP-A 0 803 743. In this context they serve as crosslinker components for polyols and/or polythiols and, depending on the reaction partner, give transparent plastics having high refractive indices in the range of from 1.56 to 1.67 and comparatively high Abbe numbers of up to 45.

All the processes mentioned so far for the preparation of polyurethane compositions of high light refraction for optical uses have the common considerable disadvantage, however, that they use large amounts of low molecular weight monomeric araliphatic diisocyanates, which are classified as sensitizing or even toxic working substances which are a health hazard and in some cases have a high vapour pressure. Processing of these monomeric diisocyanates requires a high outlay on safety for industrial hygiene reasons. There is moreover the possibility that especially if an excess of polyisocyanate is used, as proposed e.g. in EP-A 0 235 743 or EP-A 0 506 315, monomeric diisocyanate which has not reacted remains in the shaped part produced, e.g. a spectacle lens, for a relatively long time and may slowly evaporate out of this.

The main reason for the use of araliphatic diisocyanates in monomeric form is that the known low-monomer derivatives of these diisocyanates are extremely highly viscous at room temperature, and are usually even solid compounds, which have hitherto been assumed to be unsuitable as such for solvent-free uses, such as for the preparation of embedding compositions. Low-monomer polyisocyanates based on araliphatic diisocyanates accordingly are at present also used exclusively as a solution in organic solvents, e.g. for lacquers, adhesives or printing inks

The object of the present invention was therefore to provide novel highly transparent polyurethane compositions which are stable to light and weathering and have a high light refraction and low dispersion, and do not have the disadvantages of the known systems. The novel polyurethane compositions should be based on toxicologically acceptable raw materials and processable by conventional methods, for example by simple pouring by hand or with the aid of suitable machines, for example by the RIM process, to give highly crosslinked transparent shaped articles, in particular for high quality optical uses.

It has been possible to achieve this object by providing the polyurethanes described in more detail below.

The invention described below in more detail is based on the surprising observation that solvent-free low-monomer polyisocyanates based on araliphatic diisocyanates which are extremely highly viscous or even solid at room temperature can already be lowered in their viscosities by gentle heating to comparatively moderate temperatures of e.g. 50° C., to the extent that they can be processed without problems under conventional conditions to give light-fast, non-yellowing polyurethane bodies which are distinguished by a high light refraction and at the same time a high Abbe number. This was in no way to be expected, since, for example, it is known that low-monomer polyisocyanates based on cycloaliphatic or aromatic diisocyanates which are likewise solids in the solvent-free form have softening points or melting temperatures in a range significantly above 80° C.

Although, for example, in EP-A 0 329 388 and EP-A 0 378 895, the subject matter of which is processes for the production of lenses of polythiourethane or polyurethane plastics, in addition to extensive lists of diisocyanates which are potentially suitable as builder components and include, inter alia, araliphatic diisocyanates, such as e.g. XDI, bis(isocyanatoethyl)benzene, bis(isocyanatopropyl)benzene, TMXDI, bis(isocyanatobutyl)benzene, bis(isocyanatomethyl)-naphthalene or bis(isocyanatomethyl)diphenyl ether, there is also the global indication that prepolymers, urethanes, carbodiimides, ureas, biurets, dimers and trimers of the diisocyanates mentioned are likewise suitable starting polyisocyanates for the preparation of lens materials, the person skilled in the art has not been able to deduce from these publications any concrete indication at all of the particular suitability of the low-monomer araliphatic polyisocyanates described in more detail in the following for the preparation of plastics compositions having a high refractive index. Rather, the examples of these publications have also been carried out exclusively using monomeric diisocyanates, including m-XDI and m-TMXDI.

The present invention provides the use of solvent-free polyisocyanate components A) which are built up from at least two araliphatic diisocyanate molecules and have a content of isocyanate groups of from 10 to 22 wt. % and a content of monomeric diisocyanates of less than 1.0 wt. % for the production of light-fast compact or foamed polyurethane bodies.

The invention also provides a process for the preparation of light-fast polyurethane compositions by solvent-free reaction of
A) a polyisocyanate component which is built up from at least two araliphatic diisocyanates and has a content of isocyanate groups of from 10 to 22 wt. % and a content of monomeric diisocyanates of less than 1.0 wt. %, with
B) reaction partners which are reactive towards isocyanate groups and have an average functionality of from 2.0 to 6.0, and optionally co-using
C) further auxiliary substances and additives,

maintaining an equivalent ratio of isocyanate groups to groups which are reactive towards isocyanates of from 0.5:1 to 2.0:1.

Finally, the invention also provides the transparent compact or foamed shaped articles produced from the light-fast polyurethane compositions obtainable in this way.

The polyisocyanate component A) is polyisocyanates which comprise uretdione, isocyanurate, iminooxadiazinedione, urethane, allophanate, biuret and/or oxadiazinetrione groups and are based on araliphatic diisocyanates, which at 23° C. are in the solid form or have a viscosity of more than 150,000 mPas, and the content of isocyanate groups of which is from 10 to 22 wt. % and of monomeric araliphatic diisocyanates is less than 1.0 wt. %.

Suitable araliphatic starting diisocyanates for the preparation of polyisocyanate components A) are any desired diisocyanates, the isocyanate groups of which are present bonded to an optionally further substituted aromatic via optionally branched aliphatic radicals, such as e.g. 1,3-bis(isocyanatomethyl)benzene (m-xylylene-diisocyanate, m-XDI), 1,4-bis(isocyanatomethyl)benzene (p-xylylene-diisocyanate, p-XDI), 1,3-bis(2-isocyanatopropan-2-yl)benzene (m-tetramethylxylylene-diisocyanate, m-TMXDI), 1,4-bis(2-isocyanatopropan-2-yl)benzene (p-tetramethylxylylene-diisocyanate, p-TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3-bis(i socyanatomethyl)-4,5-dimethylbenzene, 1,4-bis(isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chlorobenzene, 1,3-bis(isocyanatomethyl)-4,5-dichlorobenzene, 1,3-bis(isocyanatomethyl)-2,4,5,6-tetrachlorobenzene, 1,4-bis(isocyanatomethyl)-2,3,5,6-tetrachlorobenzene, 1,4-bis(isocyanatomethyl)-2,3,5,6-tetrabromobenzene, 1,4-bis(2-isocyanatoethyl)benzene, 1,4-bis(isocyanatomethyl)naphthalene and any desired mixtures of these diisocyanates.

The preparation of the polyisocyanate components A) from the araliphatic diisocyanates mentioned can be carried out by the conventional processes for oligomerization of diisocyanates, such as are described e.g. in Laas et al., J. Prakt. Chem. 336, 1994, 185-200, and subsequent removal of the unreacted monomeric diisocyanates by distillation or extraction. Concrete examples of low-monomer polyisocyanates of araliphatic diisocyanates are to be found, for example, in JP-A 2005161691, JP-A 2005162271 and EP-A 0 081 713.

Preferred polyisocyanates A) are those having a uretdione, allophanate, isocyanurate, iminooxadiazinedione and/or biuret structure.

The polyisocyanates A) are particularly preferably those of the type described above based on m-XDI, p-XDI and/or m-TMXDI having a content of isocyanate groups of from 11 to 21.5 wt. % and a content of monomeric diisocyanates of less than 0.8%.

Very particularly preferred polyisocyanates of component A) are those of the type described above based on m-XDI having a content of isocyanate groups of from 15 to 21 wt. % and a content of monomeric m-XDI of less than 0.5%.

The araliphatic starting diisocyanates employed for the preparation of the polyisocyanate component A) can be prepared by any desired processes, e.g. by phosgenation in the liquid phase or gas phase or by a phosgene-free route, for example by urethane cleavage.

The low-monomer polyisocyanates A) are as a rule clear, practically colourless solid resins, the viscosity of which at 23° C. is more than 150,000 mPas and the content of isocyanate groups of which is preferably from 11 to 21 wt. %, particularly preferably from 15 to 21 wt. %, and the average isocyanate functionality of which is preferably from 2.2 to 5.0, particularly preferably 3.0 to 4.5. The polyisocyanates A) are low in residual monomers, since they have a residual content of monomeric araliphatic diisocyanates of less than 1.0 wt. %, preferably less than 0.8 wt. %, particularly preferably less than 0.5 wt. %.

For the preparation of the light-fast polyurethane compositions according to the invention, the polyisocyanates A) described above are reacted with any desired solvent-free reaction partners B) which are reactive towards isocyanate groups and have an average functionality in the sense of the isocyanate addition reaction of from 2.0 to 6.0, preferably from 2.5 to 4.0, particularly preferably from 2.5 to 3.5.

These are, in particular, the conventional polyether polyols, polyester polyols, polyether-polyester polyols, polythioether polyols, polymer-modified polyether polyols, graft polyether polyols, in particular those based on styrene and/or acrylonitrile, polyether-polyamines, polyacetals containing hydroxyl groups and/or aliphatic polycarbonates containing hydroxyl groups which are known from polyurethane chemistry and conventionally have a molecular weight of from 106 to 12,000, preferably 250 to 8,000. A broad overview of suitable reaction partners B) is to be found, for example, in N Adam et al.: “Polyurethanes”, Ullmann's Encyclopedia of Industrial Chemistry, Electronic Release, 7th ed., chap. 3.2-3.4, Wiley-VCH, Weinheim 2005.

Suitable polyether polyols B) are, for example, those of the type mentioned in DE-A 2 622 951, column 6, line 65—column 7, line 47, or EP-A 0 978 523 page 4, line 45 to page 5, line 14, where they correspond to that stated above with respect to functionality and molecular weight.

Particularly preferred polyether polyols B) are addition products of ethylene oxide and/or propylene oxide on glycerol, trimethylolpropane, ethylenediamine and/or pentaerythritol.

Suitable polyester polyols B) are, for example, those of the type mentioned in EP-A 0 978 523 page 5, lines 17 to 47 or EP-A 0 659 792 page 6, lines 8 to 19, where they correspond to that stated above, preferably those of which the hydroxyl number is from 20 to 650 mg of KOH/g.

Suitable polythiopolyols B) are, for example, the known condensation products of thiodiglycol with itself or other glycols, dicarboxylic acids, formaldehyde, aminocarboxylic acids and/or amino alcohols. Depending on the nature of the mixture components employed, these are polythio-mixed ether polyols, polythioether-ester polyols or polythioether-ester-amide polyols.

Polyacetal polyols which are suitable as component B) are, for example, the known reaction products of simple glycols, such as e.g. diethylene glycol, triethylene glycol, 4,4′-dioxethoxydiphenyldimethylmethane (adduct of 2 mol of ethylene oxide on bisphenol A) or hexanediol, with formaldehyde, or also polyacetals prepared by polycondensation of cyclic acetals, such as e.g. trioxane.

Aminopolyethers or mixtures of aminopolyethers, i.e. polyethers which have groups which are reactive towards isocyanate groups which are composed of primary and/or secondary, aromatically or aliphatically bonded amino groups at least to the extent of 50 equivalent %, preferably at least to the extent of 80 equivalent%, and of primary and/or secondary aliphatically bonded hydroxyl groups as the remainder, are moreover also particularly suitable as component B). Suitable such aminopolyethers are, for example, the compounds mentioned in EP-A 0 081 701, column 4, line 26 to column 5, line 40 Amino-functional polyether-urethanes or -ureas such as can be prepared, for example, by the process of DE-A 2 948 419 by hydrolysis of isocyanate-functional polyether prepolymers, or also polyesters of the above-mentioned molecular weight range containing amino groups are likewise suitable as starting component B).

Further suitable components B) which are reactive towards isocyanate groups are, for example, also the specific polyols described in EP-A 0 689 556 and EP-A 0 937 110, obtainable e.g. by reaction of epoxidized fatty acid esters with aliphatic or aromatic polyols with opening of the epoxide ring.

Polybutadienes containing hydroxyl groups can also optionally be employed as component B).

Components B) which are reactive towards isocyanate groups and are suitable for the preparation of polyurethane compositions having a very particularly high light refraction are, in particular, also polythio compounds, for example simple alkanethiols, such as e.g. methanedithiol, 1,2-ethanedithiol, 1,1-propanedithiol, 1,2-propanedithiol, 1,3-propanedithiol, 2,2-propanedithiol, 1,4-butanedithiol, 2,3-butanedithiol, 1,5-pentanedithiol, 1,6-hexanedithiol, 1,2,3-propanetrithiol, 1,1-cyclohexanedithiol, 1,2-cyclohexanedithiol, 2,2-dimethylpropane -1,3-dithiol, 3,4-dimethoxybutane-1,2-dithiol and 2-methylcyclohexane-2,3-dithiol, polythiols containing thioether groups, such as e.g. 2,4-dimercaptomethyl-1,5-dimercapto-3-thiapentane, 4-mercaptomethyl-1,8-dimercapto -3,6-dithiaoctane, 4,8-dimercaptomethyl-1,11-dimercapto-3,6,9-trithiaundecane, 4,7-dimercaptomethyl-1,11-dimercapto-3,6,9-trithiaundecane, 5,7-dimercaptomethyl -1,11-dimercapto -3,6,9-trithiaundecane, 4,5-bis(mercaptoethylthio)-1,10-dimercapto-3,8-dithiadecane, tetrakis(mercaptomethyl)methane, 1,1,3,3-tetrakis-(mercaptomethylthio)propane, 1,1,5,5-tetrakis(mercaptomethylthio)-3-thiapentane, 1,1,6,6-tetrakis(mercaptomethylthio)-3,4-dithiahexane, 2-mercaptoethylthio -1,3-dimercaptopropane, 2,3-bis(mercaptoethylthio)-1-mercaptopropane, 2,2-bis(mer)-1,3-dimercaptopropane, bis-(mercaptomethyl)sulfide, bis(mercaptomethyl)disulfide, bis(mercaptoethyl)sulfide, bis(mercaptoethyl)disulfide, bis(mercaptopropyl)sulfide, bis(mercaptopropyl)disulfide, bis(mercaptomethylthio)methane, tris(mercaptomethylthio)methane, bis(mercaptoethylthio)-methane, tris(mercaptoethylthio)methane, bis(mercaptopropylthio)methane, 1,2-bis(mercaptomethylthio)ethane, 1,2-bis(mercaptoethylthio)ethane, 2-mercaptoethylthio)ethane, 1,3-bis(mercaptomethylthio)propane, 1,3-bis(mercaptopropylthio)propane, 1,2,3-tris(mercaptomethylthio)propane, 1,2,3-tris(mercaptoethylthio)propane, 1,2,3-tris(mercaptopropylthio)propane, tetrakis(mercaptomethylthio)methane, tetrakis(mercaptoethylthiomethyl)methane, tetrakis(mercaptopropylthiomethyl)methane, 2,5-dimercapto-1,4-dithiane, 2,5-bis(mercaptomethyl)-1,4-dithiane and oligomers thereof obtainable according to JP-A 07118263, 1,5-bis(mercaptopropyl)-1,4-dithiane, 1,5-bis(2-mercaptoethylthiomethyl)-1,4-dithiane, 2-mercaptomethyl-6-mercapto -1,4-dithiacycloheptane, 2,4,6-trimercapto-1,3,5-trithiane, 2,4,6-trimercaptomethyl-1,3,5-trithiane and 2-(3-bis(mercaptomethyl)-2-thiapropyl)-1,3-dithiolane, polyester thiols, such as e.g. ethylene glycol bis(2-mercaptoacetate), ethylene glycol bis(3-mercaptopropionate), diethylene glycol (2-mercaptoacetate), diethylene glycol(3-mercaptopropionate), 2,3-dimercapto -1-propanol(3-mercaptopropionate), 3-mercapto-1,2-propanediol bis(2-mercaptoacetate), 3-mercapto-1,2-propanediol bis(3-mercaptopropionate), trimethylolpropane tris(2-mercaptoacetate), trimethylolpropane tris(3-mercaptopropionate), trimethylolethane tris(2-mercaptoacetate), trimethylolethane tris(3-mercaptopropionate), pentaerythritol tetrakis(2-mercaptoacetate), pentaerythritol tetrakis(3-mercaptopropionate), glycerol tris(2-mercaptoacetate), glycerol tris(3-mercaptopropionate), 1,4-cyclohexanediol bis(2-mercaptoacetate), 1,4-cyclohexanediol bis(3-mercaptopropionate), hydroxymethyl-sulfide bis(2-mercaptoacetate), hydroxymethyl-sulfide bis(3-mercaptopropionate), hydroxyethyl-sulfide(2-mercaptoacetate), hydroxyethyl-sulfide(3-mercaptopropionate), hydroxymethyl-disulfide(2-mercaptoacetate), hydroxymethyl-disulfide(3-mercaptopropionate), (2-mercaptoethyl ester)thioglycollate and bis(2-mercaptoethyl ester) thiodipropionate, as well as aromatic thio compounds, such as e.g. 1,2-dimercaptobenzene, 1,3-dimercaptobenzene, 1,4-dimercaptobenzene, 1,2-bis(mercaptomethyl)benzene, 1,4-bis(mercaptomethyl)benzene, 1,2-bis(mercaptoethyl)benzene, 1,4-bis(mercaptoethyl)benzene, 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 1,2,3-tris(mercaptoethyl)benzene, 1,3,5-tris(mercaptoethyl)benzene, 1,2,4-tris(mercaptoethyl)benzene, 2,5-toluenedithiol, 3,4-toluenedithiol, 1,4-naphthalenedithiol, 1,5-naphthalenedithiol, 2,6-naphthalenedithiol, 2,7-naphthalenedithiol, 1,2,3,4-tetramercaptobenzene, 1,2,3,5-tetramercaptobenzene, 1,2,4,5-tetramercaptobenzene, 1,2,3,4-tetrakis(mercaptomethyl)benzene, 1,2,3,5-tetrakis(mercaptomethyl)benzene, 1,2,4,5-tetrakis(mercaptomethyl)benzene, 1,2,3,4-tetrakis(mercaptoethyl)benzene, 1,2,3,5-tetrakis(mercaptoethyl)benzene, 1,2,4,5-tetrakis(mercaptoethyl)benzene, 2,2′-dimercaptobiphenyl and 4,4′-dimercaptobiphenyl.

Preferred polythio compounds B) are polythioether and polyester thiols of the type mentioned. Particularly preferred polythio compounds B) are 4-mercaptomethyl-1,8-dimercapto-3,6-dithiaoctane, 2,5-bismercaptomethyl-1,4-dithiane, 1,1,3,3-tetrakis(mercaptomethylthio)propane, 5,7-dimercaptomethyl -1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, trimethylolpropane tris(3-mercaptopropionate), trimethylolethane tris(2-mercaptoacetate), pentaerythritol tetrakis(2-mercaptoacetate) and pentaerythritol tetrakis(3-mercaptopropionate).

Sulfur-comprising hydroxy compounds are moreover also suitable as components B) which are reactive towards isocyanate groups. There may be mentioned here by way of example simple mercapto-alcohols, such as e.g. 2-mercaptoethanol, 3-mercaptopropanol, 1,3-dimercapto-2-propanol, 2,3-dimercaptopropanol and dithioerythritol, alcohols comprising thioether structures, such as e.g. di(2-hydroxyethyl)sulfide, 1,2-bis(2-hydroxyethylmercapto)ethane, bis(2-hydroxyethyl)disulfide and 1,4-dithiane-2,5-diol, or sulfur-comprising diols having a polyester-urethane, polythioester-urethane, polyester-thiourethane or polythioester-thiourethane structure, of the type mentioned in EP-A 1 640 394.

Low molecular weight, hydroxy- and/or amino-functional components, i.e. those having a molecular weight range of from 60 to 500, preferably from 62 to 400, can also be employed in the preparation of the light-fast polyurethane compositions according to the invention as compounds B) which are reactive towards isocyanates.

These are, for example, simple mono- or polyfunctional alcohols having 2 to 14, preferably 4 to 10 carbon atoms, such as e.g. 1,2-ethanediol, 1,2- and 1,3-propanediol, the isomeric butanediols, pentanediols, hexanediols, heptanediols and octanediols, 1,10-decanediol, 1,2- and 1,4-cyclohexanediol, 1,4-cyclohexanedimethanol, 4,4′-(1-methylethylidene)-biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol, bis-(2-hydroxyethyl)-hydroquinone, 1,2,4- and 1,3,5-trihydroxycyclohexane or 1,3,5-tris(2-hydroxyethyl)isocyanurate.

Examples of suitable low molecular weight amino-functional compounds are, for example, aliphatic and cycloaliphatic amines and amino alcohols having amino groups bonded as primary and/or secondary groups, such as e.g. cyclohexylamine, 2-methyl-1,5-pentanediamine, diethanolamine, monoethanolamine, propylamine, butylamine, dibutylamine, hexylamine, monoisopropanolamine, diisopropanolamine, ethylenediamine, 1,3-diaminopropane, 1,4-diaminobutane, isophoronediamine, diethylenetriamine, ethanolamine, aminoethylethanolamine, diaminocyclohexane, hexamethylenediamine, methyliminobispropylamine, iminobispropylamine, bis(aminopropyl)piperazine, aminoethylpiperazine, 1,2-diaminocyclohexane, triethylenetetramine, tetraethylenepentamine, 1,8-p-diaminomenthane, bis(4-aminocyclohexyl)methane, bis(4-amino-3-methylcyclohexyl)methane, bis(4-amino-3,5-dimethylcyclohexyl)methane, bis(4-amino-2,3,5-trimethylcyclohexyl)methane, 1,1-bis(4-aminocyclohexyl)propane, 2,2-bis(4-aminocyclohexyl)propane, 1,1-bis(4-aminocyclohexyl)ethane, 1,1-bis(4-aminocyclohexyl)butane, 2,2-bis(4-aminocyclohexyl)butane, 1,1-bis(4-amino-3-methylcyclohexyl)ethane, 2,2-bis(4-amino-3-methylcyclohexyl)propane, 1,1-bis(4-amino-3,5-dimethylcyclohexyl)ethane, 2,2-bis(4-amino-3,5-dimethylcyclohexyl)propane, 2,2-bis(4-amino-3,5-dimethylcyclohexyl)butane, 2,4-diaminodicyclohexylmethane, 4-aminocyclohexyl-4-amino-3-methylcyclohexylmethane, 4-amino-3,5-dimethylcyclohexyl-4-amino-3-methylcyclohexyl-methane and 2-(4-aminocyclohexyl)-2-(4-amino-3-methylcyclohexyl)methane.

Examples of aromatic polyamines, in particular diamines, having molecular weights below 500 which are suitable compounds B) which are reactive towards isocyanates are e.g. 1,2- and 1,4-diaminobenzene, 2,4- and 2,6-diaminotoluene, 2,4′- and/or 4,4′-diaminodiphenylmethane, 1,5-diaminonaphthalene, 4,4′,4″-triaminotriphenylmethane, 4,4′-bis-(methylamino)-diphenylmethane or 1-methyl-2-methylamino-4-aminobenzene, 1-methyl-3,5-diethyl-2,4-diaminobenzene, 1-methyl-3,5-diethyl-2,6-diaminobenzene, 1,3,5-trimethyl-2,4-diaminobenzene, 1,3,5-triethyl-2,4-diaminobenzene, 3,5,3′,5′-tetraethyl-4,4′-diaminodiphenylmethane, 3,5,3′,5′-tetraisopropyl-4,4′-diaminodiphenylmethane, 3,5-diethyl-3′,5′-diisopropyl-4,4′-diaminodiphenylmethane, 3,3′-diethyl-5,5′-diisopropyl-4,4′-diaminodiphenylmethane, 1-methyl-2,6-diamino-3-isopropylbenzene, liquid mixtures of polyphenylpolymethylenepolyamines, such as are obtainable in a known manner by condensation of aniline with formaldehyde, and any desired mixtures of such polyamines In this connection, for example, mixtures of 1-methyl-3,5-diethyl-2,4-diaminobenzene with 1-methyl-3,5-diethyl-2,6-diaminobenzene in a weight ratio of from 50:50 to 85:15, preferably from 65:35 to 80:20 may be mentioned in particular.

The use of low molecular weight amino-functional polyethers having molecular weights below 500 is likewise possible. These are, for example, those with primary and/or secondary, aromatically or aliphatically bonded amino groups, the amino groups of which are optionally bonded to the polyether chains via urethane or ester groups and which are accessible by known processes already described above for the preparation of the higher molecular weight aminopolyethers.

Sterically hindered aliphatic diamines having two amino groups bonded as secondary groups can optionally also be employed as components B) which are reactive towards isocyanate groups, such as e.g. the reaction products, known from EP-A 0 403 921, of aliphatic and/or cycloaliphatic diamines with maleic acid esters or fumaric acid esters, the bis-adduct, obtainable according to the teaching of EP-A 1 767 559, of acrylonitrile on isophoronediamine, or the hydrogenation products, described for example in DE-A 19 701 835, of Schiff's bases accessible from aliphatic and/or cycloaliphatic diamines and ketones, such as e.g. diisopropyl ketone.

Preferred reaction partners B) for the polyisocyanate mixtures A) are the above-mentioned polymeric polyether polyols, polyester polyols and/or aminopolyethers, the polythio compounds mentioned, low molecular weight aliphatic and cycloaliphatic polyfunctional alcohols and the low molecular weight polyfunctional amines mentioned, in particular sterically hindered aliphatic diamines having two amino groups bonded as secondary groups.

Any desired mixtures of the components B) which are reactive towards isocyanate groups and are mentioned above by way of example are also suitable as reaction partners for the polyisocyanate mixtures A). While pure polyurethane compositions are obtained using exclusively hydroxy-functional components B), pure polythiourethanes are obtained with the exclusive use of thio compounds B) and pure polyurea compositions are obtained with the exclusive use of polyamines B), by using amino alcohols, mercapto-alcohols or suitable mixtures of hydroxy-, mercapto- and amino-functional compounds as component B), polyaddition compounds in which the equivalent ratio of urethane to thiourethane and/or urea groups can be adjusted as desired can be prepared.

The polyisocyanate components A) are as a rule employed as the sole polyisocyanate component in the preparation of light-fast polyurethane compositions. However, it is also possible in principle to employ the polyisocyanate components A) in a mixture with any desired further solvent-free low-monomer polyisocyanates, for example the known lacquer polyisocyanates based on hexamethylene-diisocyanate (HDI) having a uretdione, isocyanurate, allophanate, biuret, iminooxadiazinedione and/or oxadiazinetrione structure, such as are described by way of example, for example, in J. Prakt. Chem. 336 (1994) 185-200 and EP-A 0 798 299, the solutions, known from EP-A 0 693 512 and EP-A 1 484 350, of cycloaliphatic polyisocyanates in low-viscosity HDI polyisocyanates, the solvent-free polyisocyanates, described in EP-A 0 047 452 and EP-A 0 478 990, obtainable from mixtures of HDI and isophorone-diisocyanate (IPDI) by dimerization and/or trimerization, or polyester-modified HDI polyisocyanates of the type known from EP-A 0 336 205.

Regardless of the nature of the starting substances chosen, in the process according to the invention the reaction of the polyisocyanate mixtures A) with the components B) which are reactive towards isocyanate groups is carried out maintaining an equivalent ratio of isocyanate groups to groups which are reactive towards isocyanates of from 0.5:1 to 2.0:1, preferably from 0.7:1 to 1.3:1, particularly preferably from 0.8:1 to 1.2:1.

In addition to the starting components A) and B) mentioned, further auxiliary substances and additives C) can optionally be co-used in this context, such as e.g. catalysts, blowing agents, surface-active agents, UV stabilizers, foam stabilizers, antioxidants, mould release agents, fillers and pigments.

Conventional catalysts known from polyurethane chemistry, for example, can be employed to accelerate the reaction. There may be mentioned here by way of example tertiary amines, such as e.g. triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis-(dimethylaminopropyl)-urea, N-methyl- and N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylenetriamine, N-methylpiperidine, N-dimethylaminoethylpiperidine, N,N′-dimethylpiperazine, N-methyl-N′-dimethylaminopiperazine, 1,8-diazabicyclo(5.4.0)undec-7-ene (DBU), 1,2-dimethylimidazole, 2-methylimidazole, N,N-dimethylimidazole-β-phenylethylamine, 1,4-diazabicyclo-(2,2,2)-octane, bis-(N,N-dimethylaminoethyl)adipate; alkanolamine compounds, such as e.g. triethanolamine, triisopropanolamine, N-methyl- and N-ethyl-diethanolamine, dimethylamino ethanol, 2-(N,N-dimethylaminoethoxy)ethanol, N,N′,N″-tris-(dialkylaminoalkyl)hexahydrotriazines, e.g. N,N′,N″-tris-(dimethylaminopropyl)-s-hexahydrotriazine and/or bis(dimethylaminoethyl) ether; metal salts, such as e.g. inorganic and/or organic compounds of iron, lead, bismuth, zinc and/or tin in conventional oxidation levels of the metal, for example iron(II) chloride, iron(III) chloride, bismuth(III) . . . , bismuth(III) 2-ethylhexanoate, bismuth(III) octoate, bismuth(III) neodecanoate, zinc chloride, zinc 2-ethylcaproate, tin(II) octoate, tin(II) ethylcaproate, tin(II) palmitate, dibutyltin(IV) dilaurate (DBTL), dibutyltin(IV) dichloride or lead octoate; amidines, such as e.g. 2,3-dimethyl-3,4,5,6-tetrahydropyrimidine; tetraalkylammonium hydroxides, such as e.g. tetramethylammonium hydroxide; alkali metal hydroxides, such as e.g. sodium hydroxide, and alkali metal alcoholates, such as e.g. sodium methylate and potassium isopropylate, and alkali metal salts of long-chain fatty acids having 10 to 20 C atoms and optionally side-chain OH groups.

Preferred catalysts C) to be employed are tertiary amines and bismuth and tin compounds of the type mentioned.

The catalysts mentioned by way of example can be employed individually or in the form of any desired mixtures with one another in the preparation of the light-fast polyurethane, polythiourethane and/or polyurea compositions according to the invention, and are optionally employed in this context in amounts of from 0.01 to 5.0 wt. %, preferably 0.1 to 2 wt. %, calculated as the total amount of catalysts employed, based on the total amount of starting compounds used.

Transparent compact shaped parts having a high refractive index are preferably produced by the process according to the invention. By addition of suitable blowing agents, however, foamed shaped articles can also be obtained if desired. Blowing agents which are suitable for this are, for example, readily volatile organic substances, such as e.g. acetone, ethyl acetate, halogen-substituted alkanes, such as methylene chloride, chloroform, ethylidene chloride, vinylidene chloride, monofluorotrichloromethane, chlorotrifluoromethane or dichlorodifluoromethane, butane, hexane, heptane or diethyl ether and/or dissolved inert gases, such as e.g. nitrogen, air or carbon dioxide.

Possible chemical blowing agents C), i.e. blowing agents which form gaseous products due to a reaction, for example with isocyanate groups, are, for example, water, compounds containing water of hydration, carboxylic acids, tertiary alcohols, e.g. t-butanol, carbamates, for example the carbamates described in EP-A 1 000 955, in particular on page 2, lines 5 to 31 and page 3, lines 21 to 42, carbonates, e.g. ammonium carbonate and/or ammonium bicarbonate and/or guanidine carbamate. A blowing action can also be achieved by addition of compounds which decompose at temperatures above room temperature with splitting off of gases, for example nitrogen, e.g. azo compounds, such as azodicarboxamide or azoisobutyric acid nitrile. Further examples of blowing agents and details of the use of blowing agents are described in Kunststoff-Handbuch, volume VII, published by Vieweg und Höchtlen, Carl-Hanser-Verlag, Munich 1966, e.g. on pages 108 and 109, 453 to 455 and 507 to 510.

A blowing action can also be achieved by addition of compounds which decompose at temperatures above room temperature with splitting off of gases, for example nitrogen, e.g. azo compounds, such as azodicarboxamide or azoisobutyric acid nitrile. Further examples of blowing agents and details of the use of blowing agents are described in Kunststoff-Handbuch, volume VII, published by Vieweg und Höchtlen, Carl-Hanser-Verlag, Munich 1966, e.g. on pages 108 and 109, 453 to 455 and 507 to 510.

According to the invention, surface-active additives C) can also be co-used as emulsifiers and foam stabilizers. Suitable emulsifiers are, for example, the sodium salts of castor oil sulfonates or fatty acids, and salts of fatty acids with amines, such as e.g. diethylamine oleate or diethanolamine stearate. Alkali metal or ammonium salts of sulfonic acids, such as e.g. of dodecylbenzenesulfonic acids, fatty acids, such as ricinoleic acid, or polymeric fatty acids, or ethoxylated nonylphenol can also be co-used as surface-active additives.

Suitable foam stabilizers are, in particular, the known, preferably water-soluble polyether siloxanes such as are described, for example, in U.S. Pat. No. 2,834,748, DE-A 1 012 602 and DE-A 1 719 238. The polysiloxane/polyoxyalkylene copolymers branched via allophanate groups, obtainable according to DE-A 2 558 523, are also suitable foam stabilizers.

The above-mentioned emulsifiers and stabilizers optionally to be co-used in the process according to the invention can be employed both individually and in any desired combinations with one another.

The bodies obtained from the polyurethane compositions which can be prepared and used according to the invention are already distinguished as such, i.e. without the addition of corresponding stabilizers, by a very good stability to light. Nevertheless, UV protection agents (light stabilizers) or antioxidants of the known type can optionally be co-used as further auxiliary substances and additives C) in their production.

Suitable UV stabilizers C) are, for example, piperidine derivatives, such as e.g. 4-benzoyloxy-2,2,6,6-tetramethylpiperidine, 4-benzoyloxy-1,2,2,6,6-pentamethylpiperidine, bis-(2,2,6,6-tetramethyl-4-piperidyl)sebacate, bis-(1,2,2,6,6-pentamethyl-4-piperidyl)sebacate, methyl(1,2,2,6,6-pentamethyl-4-piperidyl)sebacate, bis-(2,2,6,6-tetramethyl-4-piperidyl)suberate or bis-(2,2,6,6-tetramethyl-4-piperidyl)dodecanedioate, benzophenone derivatives, such as e.g. 2,4-dihydroxy-, 2-hydroxy-4-methoxy-, 2-hydroxy-4-octoxy-, 2-hydroxy-4-dodecyloxy- or 2,2′-dihydroxy-4-dodecyloxy-benzophenone, benzotriazole derivatives, such as e.g. 2-(5-methyl-2-hydroxyphenyl)benzotriazole, 2-(5-tert-butyl-2-hydroxyphenyl)benzotriazole, 2-(5-tert-octyl-2-hydroxyphenyl)benzotriazole, 2-(5-dodecyl-2-hydroxyphenyl)b enzotriazole, 2-(3,5-di-tert-butyl-2-hydroxyphenyl)-5-chlorobenzotriazole, 2-(3,5-di-tert-amyl-2-hydroxyphenyl)benzotriazole, 2-(3,5-di-tert-butyl-2-hydroxyphenyl)benzotriazole, 2-(3-tert-butyl-5-methyl-2-hydroxyphenyl)-5-chlorobenzotriazole and esterification products of 2-(3-tert-butyl-5-propionic acid-2-hydroxyphenyl)benzotriazole with polyethylene glycol 300, oxalanilides, such as e.g. 2-ethyl-2′-ethoxy- or 4-methyl-4′-methoxyoxalanilide, salicylic acid esters, such as e.g. salicylic acid phenyl ester, salicylic acid 4-tert-butylphenyl ester and salicylic acid 4-tert-octylphenyl ester, cinnamic acid ester derivatives, such as e.g. α-cyano-β-methyl-4-methoxycinnamic acid methyl ester, α-cyano-β-methyl-4-methoxycinnamic acid butyl ester, α-cyano-β-phenylcinnamic acid ethyl ester and α-cyano-β-phenylcinnamic acid isooctyl ester, or malonic ester derivatives, such as e.g. 4-methoxybenzylidenemalonic acid dimethyl ester, 4-methoxybenzylidenemalonic acid diethyl ester and 4-butoxybenzylidenemalonic acid dimethyl ester. These light stabilizers can be employed both individually and in any desired combinations with one another.

Suitable antioxidants C) are, for example, the known sterically hindered phenols, such as e.g. 2,6-di-tert-butyl-4-methylphenol (Ionol), pentaerythritol tetrakis(3-(3,5-di-tert-butyl-4-hydroxyphenyl)propionate), octadecyl 3-(3,5-di-tert-butyl-4-hydroxyphenyl)-propionate, triethylene glycol bis(3-tert-butyl-4-hydroxy-5-methylphenyl)propionate, 2,2′-thio-bis(4-methyl-6-tert-butylphenol), 2,2′-thiodiethyl bis[3-(3,5-di-tert-butyl-4-hydroxyphenyl)-propionate), which are employed both individually and in any desired combinations with one another.

Further auxiliary substances and additives C) which are optionally to be co-used are, for example, cell regulators of the type known per se, such as e.g. paraffins or fatty alcohols, the known flameproofing agents, such as e.g. tris-chloroethyl phosphate, ammonium phosphate or polyphosphate, fillers, such as e.g. barium sulfate, kieselguhr, carbon black, prepared chalk or also reinforcing glass fibres. Finally, the internal mould release agents, dyestuffs, pigments, hydrolysis stabilizers and fungistatically and bacteriostatically acting substances known per se can optionally also be co-used in the process according to the invention.

The auxiliary substances and additives C) mentioned which are optionally to be co-used can be admixed both to the polyisocyanate component A) and/or to the component B) which is reactive towards isocyanate groups.

For the production of the light-fast bodies according to the invention from polyurethane compositions, the low-monomer polyisocyanates A) are mixed, with the aid of suitable mixing units, with the component B) which is reactive towards isocyanate groups, optionally co-using the above-mentioned auxiliary substances and additives C), in a solvent-free form in the above-mentioned equivalent ratio of isocyanate groups to groups which are reactive towards isocyanates, and the mixture is cured by any desired methods in open or closed moulds, for example by simple manual pouring, but preferably with the aid of suitable machines, such as e.g. the conventional low pressure or high pressure machines in polyurethane technology, or by the RIM process, in a temperature range of from 40 to 180° C., preferably from 50 to 140° C., particularly preferably from 60 to 120° C., and optionally under an increased pressure of up to 300 bar, preferably up to 100 bar, particularly preferably up to 40 bar.

In this procedure, the polyisocyanates A) and optionally also the starting components B) are preheated to a temperature of at least 40° C., preferably at least 50° C., particularly preferably at least 60° C. to reduce the viscosities, and optionally degassed by application of a vacuum.

As a rule, the bodies produced in this way from the polyurethane compositions which are prepared and can be used according to the invention can be removed from the mould after a short time, for example after a time of from 2 to 60 min. If appropriate, a post-curing at a temperature of from 50 to 100° C., preferably at 60 to 90° C., can follow.

Compact or foamed, light- and weather-resistant polyurethane bodies which are distinguished by a high resistance to solvents and chemicals and outstanding mechanical properties, in particular an excellent heat distortion point also at higher temperatures of, for example, 90° C., are obtained in this manner.

Preferably, the low-monomer araliphatic polyisocyanates A) are used for the production of compact transparent shaped bodies. These transparent polyurethane bodies are suitable for a large number of different uses, for example for the production of or as glass substitute panes, such as e.g. sunroofs, front, rear or side screens in vehicle or aircraft construction, and as safety glass.

The polyurethane compositions according to the invention are moreover also outstandingly suitable for transparent embedding of optical, electronic or optoelectronic components, such as e.g. of solar modules, light-emitting diodes or of lenses or collimators, such as are employed, for example, as a supplementary lens in LED lamps or automobile headlamps.

A particularly preferred field of use for the polyurethane compositions according to the invention obtainable from the low-monomer araliphatic polyisocyanates A) is, however, the production of lightweight spectacle lenses of plastic which have a high refractive index and high Abbe number. Spectacle lenses produced according to the invention are distinguished by outstanding mechanical properties, in particular hardness and impact strength as well as good scratch resistance, and moreover are easy to work and can be coloured as desired.

### EXAMPLES

Unless noted otherwise, all the percentage data relate to the weight.

The NCO contents were determined titrimetrically in accordance with DIN EN ISO 11909.

OH numbers were determined titrimetrically in accordance with the method of DIN 53240 Part 2, and acid numbers in accordance with DIN 3682.

The residual monomer contents were measured by gas chromatography with an internal standard in accordance with DIN EN ISO 10283.

All the viscosity measurements were made with a Physica MCR 51 Rheometer from Anton Paar Germany GmbH (DE) in accordance with DIN EN ISO 3219.

The glass transition temperature Tg was determined by means of DSC (differential scanning calorimetry) using a Mettler DSC 12E (Mettler Toledo GmbH, Giessen, DE) at a heating up rate of 20° C./min.

Shore hardnesses were measured in accordance with DIN 53505 with the aid of a Zwick 3100 Shore hardness test apparatus (Zwick, DE).

The refractive indices and Abbe numbers were measured on an Abbe refractometer, model B from Zeiss.

Starting Compounds

Polyisocyanate A1)

By the process described in EP-A 0 157 088, Example 6, 2,256 g (12 mol) of 1,3-bis(isocyanatomethyl)benzene (m-XDI) were reacted with 18 g (1 mol) of water in the presence of 46.5 g (0.25 mol) of pivalic anhydride and 200 g of triethyl phosphate to give a biuret polyisocyanate. Excess m-XDI was then removed by thin film distillation at a temperature of 150° C. under a pressure of 0.1 mbar. A highly viscous pale yellow-coloured resin was obtained.

NCO content: 21.1%

NCO functionality: 3.3

Monomeric m-XDI: 0.3%

Viscosity (23° C.): 182,000 mPas

Viscosity (60° C.): 1,500 mPas

Polyisocyanate A2)

1.4 g (7 mmol) of tributylphosphine as a catalyst were added to 940 g (5.0 mol) of m-XDI at room temperature, under nitrogen and while stirring, and the mixture was then heated to 60° C. After approx. one hour, the NCO content of the mixture had fallen to 26.4% and the reaction was interrupted by addition of 1.3 g (7 mmol) of methyl toluenesulfonate and heating at 80° C. for one hour. After removal of the unreacted excess m-XDI by thin film distillation at a temperature of 150° C. under a pressure of 0.1 mbar, a polyisocyanate comprising isocyanurate groups and uretdione groups was obtained in the form of a vitreous, almost colourless resin.

NCO content: 17.4%

NCO functionality: 2.4

Monomeric m-XDI: 0.2%

Viscosity (60° C.): 6,800 mPas

Polyisocyanate A3)

m-XDI polyisocyanate comprising isocyanurate groups and iminooxadiazinedione groups prepared by the process described in Example 4 of EP-A 0 962 455 by trimerization of m-XDI using a 50% strength solution of tetrabutylphosphonium hydrogen difluoride in isopropanol/methanol (2:1) as the catalyst and stopping of the reaction at an NCO content of the crude mixture of 36% by addition of dibutyl phosphate. After removal of the unreacted m-XDI by thin film distillation at a temperature of 150° C. under a pressure of 0.1 mbar, a vitreous solid resin with the following characteristic data was obtained:

NCO content: 20.4%

NCO functionality: 3.2

Monomeric m-XDI: 0.1%

Viscosity (60° C.): 8,500 mPas

Hydroxy-Functional Reaction Partner B1)

Solvent-free polyester polyol, prepared as described in WO 2010/083958 under starting compounds as the hydroxy-functional reaction partner B1).

Viscosity (23° C.): 19,900 mPas

OH number: 628 mg of KOH/g

Acid number: 2.2 mg of KOH/g

OH functionality: 2.6

Average molecular weight: 243 g/mol (calculated from the OH number)

Mercapto-Functional Reaction Partner B2)

Pentaerythritol tetrakis(3-mercaptopropionate) (=THIOCURE® PETMP, Bruno Bock, DE)

Equivalent weight: 122.2 g/eq of SH

### Examples 1 to 8

### Preparation of Polyurethane Embedding Compositions

For the preparation of embedding compositions, the low-monomer polyisocyanates A) and polyol components B) were preheated to 60° C. in the combinations and ratios of amounts (parts by wt.) stated in Table 1, in each case corresponding to an equivalent ratio of isocyanate groups to groups which are reactive towards isocyanate groups of 1:1, and the mixture was homogenized with the aid of a SpeedMixer DAC 150 FV (Hauschild, DE) at 3,500 rpm for 1 min and then poured manually into open, non-heated polypropylene moulds. After curing at 70° C. in a drying cabinet for 24 hours, the test specimens (diameter 50 mm, height 5 mm) were removed from the mould.

After a post-curing time of a further 24 hours at room temperature, the test specimens were tested for their mechanical and optical properties. The test results are likewise to be found in the following Table.

| | Example | | | | | |
|---|---|---|---|---|---|---|
| | 1 | 2 | 3 | 4 | 5 | 6 |
| Polyisocyanate A1) | 69.0 | — | — | 62.0 | — | — |
| Polyisocyanate A2) | — | 73.0 | — | — | 66.4 | — |
| Polyisocyanate A3) | — | — | 69.8 | — | — | 62.8 |
| Reaction partner B1) | 31.0 | 27.0 | 30.2 | — | — | |
| Reaction partner B2) | — | — | — | 38.0 | 33.6 | 37.2 |
| Appearance | clear | clear | clear | clear | clear | clear |
| Tg [° C.] | 116 | 102 | 133 | 123 | 117 | 123 |
| Shore D hardness | 84 | 89 | 91 | 90 | 88 | 89 |
| Refractive index n_{D}²⁰ | 1.5769 | 1.5801 | 1.5782 | 1.6080 | 1.6113 | 1.5995 |
| Abbe number | 39 | 38 | 40 | 37 | 38 | 36 |

1. Method of producing light-fast compact or foamed polyurethane bodies using solvent-free polyisocyanate components A) which are built up from at least two araliphatic diisocyanates and have a content of isocyanate groups of from 10 to 22 wt. % and a content of monomeric diisocyanates of less than 1.0 wt. %.

2. Method according to claim 1, wherein the polyisocyanate components A) have uretdione, allophanate, isocyanurate, iminooxadiazinedione and/or biuret structures.

3. Method according to claim 1, wherein the polyisocyanate components A) are polyisocyanates based on 1,3-bis(isocyanatomethyl)benzene, 1,4-bis(isocyanatomethyl)benzene and/or 1,3-bis(2-isocyanatopropan-2-yl)benzene having a content of isocyanate groups of from 11 to 21.5 wt. % and a content of monomeric diisocyanates of less than 0.8%.

4. Method according to claim 3, wherein the polyisocyanate components A) are polyisocyanates based on 1,3-bis(isocyanatomethyl)benzene having a content of isocyanate groups of from 15 to 21 wt. % and a content of monomeric diisocyanate of less than 0.5%.

5. Method according to claim 1, wherein in the preparation of the polyisocyanate components A), the unreacted monomeric araliphatic diisocyanate is removed from the reaction product by extraction or thin film distillation.

6. Method according to claim 1, which produces compact transparent polyurethane bodies.

7. Method according to claim 6, wherein the polyurethane bodies are glass substitute parts.

8. Method according to claim 6, wherein the polyurethane bodies are optical, optoelectronic or electronic components.

9. Method according to claim 6, wherein the components are optical lenses or spectacle lenses.

10. Method according to claim 6, wherein the components are light-emitting diodes.

11. Process for the production of light-fast polyurethane bodies comprising solvent-free reacting of:
A) a polyisocyanate component which is built up from at least two araliphatic diisocyanates and has a content of isocyanate groups of from 10 to 22 wt. % and a content of monomeric diisocyanates of less than 1.0 wt. %, with
B) reaction partners which are reactive towards isocyanate groups and have an average functionality of from 2.0 to 6.0, and optionally co-using
C) further auxiliary substances and additives,
maintaining an equivalent ratio of isocyanate groups to groups which are reactive towards isocyanates of from 0.5:1 to 2.0:1.

12. Process according to claim 11, wherein hydroxy-, amino- and/or mercapto-functional compounds having an average molecular weight of from 60 to 12,000 are employed as component B).

13. Process according to claim 11, wherein polyether polyols, polyester polyols, polycarbonate polyols and/or aminopolyethers having an average molecular weight of from 106 to 12,000, polythioether thiols, polyester thiols, sulfur-containing hydroxy compounds and/or low molecular weight hydroxy- and/or amino-functional components having an average molecular weight of from 60 to 500 are employed as component B).

14. Process according to claim 11, wherein catalysts, UV stabilizers, antioxidants and/or mould release agents are employed as component C.

15. Process according to claim 11, wherein the reaction of the reaction partners is carried out at a temperature of up to 180° C. under a pressure of up to 300 bar.
